(19) United States
(12) Patent Application Publication
(10) Pub. No.: US 2002/0037046 A1
(43) Pub. Date: Mar. 28, 2002

(54) Totally embedded FGS video coding with motion compensation

(75) Inventors: Mihaela Van Der Schaar, Ossining, NY (US); Hayder Radha, East Lansing, MI (US)

Correspondence Address: Corporate Patent Counsel, Philips Electronics North America Corporation, 580 White Plains Road, Tarrytown, NY, 10591, US

(73) Assignee: Philips Electronics North America Corporation

(21) Appl. No.: 09/930,672

(22) Filed: Aug. 15, 2001

Related U.S. Application Data
(60) Provisional application No. 60/234,499, filed on Sep. 22, 2000.
(60) Provisional application No. 60/239,661, filed on Oct. 12, 2000.

(51) Int. Cl. H04N 7/12

(52) U.S. Cl. 375/240.2; 375/240.19; 375/240.12; 375/240.01

(57) ABSTRACT

A scalable video coding scheme having a single motion compensation loop that generates bi-directional predicted frames (B frames) or predicted frames and bi-directional predicted frames and (P and B frames) coded entirely with a scalable codec.

### RELATED APPLICATIONS

Commonly-assigned, copending U.S. patent application Ser. No. ______, entitled “Double-Loop Motion-Compensation Fine Granular Scalability”, filed ______, 2001.

Commonly-assigned, copending U.S. Patent Application, No. , entitled “Single-Loop Motion-Compensation Fine Granular Scalability”, filed ______, 2001.

### FIELD OF THE INVENTION

The present invention relates to video coding, and more particularly to a scalable video coding scheme that employs a single motion compensation loop for generating bidirectional predicted frames (B frames) or predicted frames and bi-directional predicted frames and (P and B frames) coded entirely with fine granular scalable (FGS) coding.

### BACKGROUND OF THE INVENTION

Scalable enhancement layer video coding has been used for compressing video transmitted over computer networks having a varying bandwidth, such as the Internet. A current enhancement layer video coding scheme employing FGS coding techniques (adopted by the ISO MPEG-4 standard) is shown in FIG. 1. As can be seen, the video coding scheme 10 includes a prediction-based base layer 11 coded at a bit rate RBL, and an FGS enhancement layer 12 coded at R_{EL}.

The prediction-based base layer 11 includes intraframe coded I frames, interframe coded P frames which are temporally predicted from previous I or P frames using motion estimation-compensation, and interframe coded bi-directional B frames which are temporally predicted from both previous and succeeding frames adjacent the B frame using motion estimation-compensation. The use of predictive and/or interpolative coding i.e., motion estimation and corresponding compensation, in the base layer 11 reduces temporal redundancy therein, but only to a limited extent, since only base layer frames are used for prediction.

The enhancement layer 12 includes FGS enhancement layer I, P, and B frames derived by subtracting their respective reconstructed base layer frames from the respective original frames (this subtraction can also take place in the motion-compensated domain). Consequently, the FGS enhancement layer I, P and B frames in the enhancement layer are not motion-compensated. (The FGS residual is taken from frames at the same time-instance.) The primary reason for this is to provide flexibility which allows truncation of each FGS enhancement layer frame individually depending on the available bandwidth at transmission time. More specifically, the fine granular scalable coding of the enhancement layer 12 permits an FGS video stream to be transmitted over any network session with an available bandwidth ranging from Rₘᵢₙ=R_{BL} to Rₘₐₓ=R_{BL}+R_{EL}. For example, if the available bandwidth between the transmitter and the receiver is B=R, then the transmitter sends the base layer frames at the rate R_{BL} and only a portion of the enhancement layer frames at the rate R_{EL}=R−R_{BL}. As can be seen from FIG. 1, portions of the FGS enhancement layer frames in the enhancement layer can be selected in a fine granular scalable manner for transmission. Therefore, the total transmitted bit-rate is R=R_{BL}+R_{EL}. Because of its flexibility in supporting a wide range of transmission bandwidth with a single enhancement layer.

FIG. 2 shows a block-diagram of a conventional FGS encoder for coding the base layer 11 and enhancement layer 12 of the video coding scheme of FIG. 1. As can be seen, the enhancement layer residual of frame i (FGSR(i)) equals MCR(i)−MCRQ(i), where MCR(i) is the motion-compensated residual of frame i, and MCRQ(i) is the motion-compensated residual of frame i after the quantization and the dequantization processes.

Although the current FGS enhancement layer video coding scheme 10 of FIG. 1 is very flexible, it has the disadvantage that its performance in terms of video image quality is relatively low compared with that of a non-scalable coder functioning at the same transmission bit-rate. The decrease in image quality is not due to the fine granular scalable coding of the enhancement layer 12 but mainly due to the reduced exploitation of the temporal redundancy among the FGS residual frames within the enhancement layer 12. In particular, the FGS enhancement layer frames of the enhancement layer 12 are derived only from the motion-compensated residual of their respective base layer I, P, and B frames, no FGS enhancement layer frames are used to predict other FGS enhancement layer frames in the enhancement layer 12 or other frames in the base layer 11.

Accordingly, a scalable video coding scheme having improved video image quality is needed.

### SUMMARY OF THE INVENTION

The present invention is directed to a scalable video coding scheme that employs a single motion compensation loop for generating bi-directional predicted frames (B frames) or predicted frames and bi-directional predicted frames and (P and B frames) coded entirely with fine granular scalable (FGS) coding. One aspect of the invention involves a method of coding video comprising the steps of: encoding an uncoded video to generate extended base layer reference frames, each of the extended base layer reference frames including a base layer reference frame and at least a portion of an associated enhancement layer reference frame; and predicting frame residuals from the uncoded video and the extended base layer reference frames.

Another aspect of the invention involves a method of decoding a compressed video having a base layer stream and an enhancement layer stream, comprising the steps of: decoding the base layer and enhancement layer streams to generate extended base layer reference frames, each of the extended base layer reference frames including a base layer reference frame and at least a portion of an associated enhancement layer reference frame; and predicting frame residuals from the extended base layer reference frames.

Still another aspect of the invention involves a memory medium for coding video, comprising: code for encoding an uncoded video to generate extended base layer reference frames, each of the extended base layer reference frames including a base layer reference frame and at least a portion of an associated enhancement layer reference frame; and code for predicting frame residuals from the uncoded video and the extended base layer reference frames.

A further aspect of the invention involves a memory medium for decoding a compressed video having a base layer stream and an enhancement layer stream, comprising: code for decoding the base layer and enhancement layer streams to generate extended base layer reference frames, each of the extended base layer reference frames including a base layer reference frame and at least a portion of an associated enhancement layer reference frame; and code for predicting frame residuals from the extended base layer reference frames.

Still a further aspect of the invention involves an apparatus for coding video, which comprises: means for encoding an uncoded video to generate extended base layer reference frames, each of the extended base layer reference frames including a base layer reference frame and at least a portion of an associated enhancement layer reference frame; and means for predicting frame residuals from the uncoded video and the extended base layer reference frames.

Still another aspect of the invention involves an apparatus for decoding a compressed video having a base layer stream and an enhancement layer stream, which comprises: means for decoding the base layer and enhancement layer streams to generate extended base layer reference frames, each of the extended base layer reference frames including a base layer reference frame and at least a portion of an associated enhancement layer reference frame; and means for predicting frame residuals from the extended base layer reference frames.

### BRIEF DESCRIPTION OF THE DRAWINGS

The advantages, nature, and various additional features of the invention will appear more fully upon consideration of the illustrative embodiments now to be described in detail in connection with accompanying drawings where like reference numerals identify like elements throughout the drawings:

FIG. 1 shows a current enhancement layer video coding scheme;

FIG. 2 shows a block-diagram of a conventional encoder for coding the base layer and enhancement layer of the video coding scheme of FIG. 1;

FIG. 3A shows a scalable video coding scheme according to a first exemplary embodiment of the present invention;

FIG. 3B shows a scalable video coding scheme according to a second exemplary embodiment of the present invention;

FIG. 4 shows a block-diagram of an encoder, according to an exemplary embodiment of the present invention, that may be used for generating the scalable video coding scheme of FIG. 3A;

FIG. 5 shows a block-diagram of an encoder, according to an exemplary embodiment of the present invention, that may be used for generating the scalable video coding scheme of FIG. 3B;

FIG. 6 shows a block-diagram of a decoder, according to an exemplary embodiment of the present invention, that may be used for decoding the compressed base layer and enhancement layer streams generated by the encoder of FIG. 4;

FIG. 7 shows a block-diagram of a decoder, according to an exemplary embodiment of the present invention, that may be used for decoding the compressed base layer and enhancement layer streams generated by the encoder of FIG. 5; and

FIG. 8 shows an exemplary embodiment of a system which may be used for implementing the principles of the present invention.

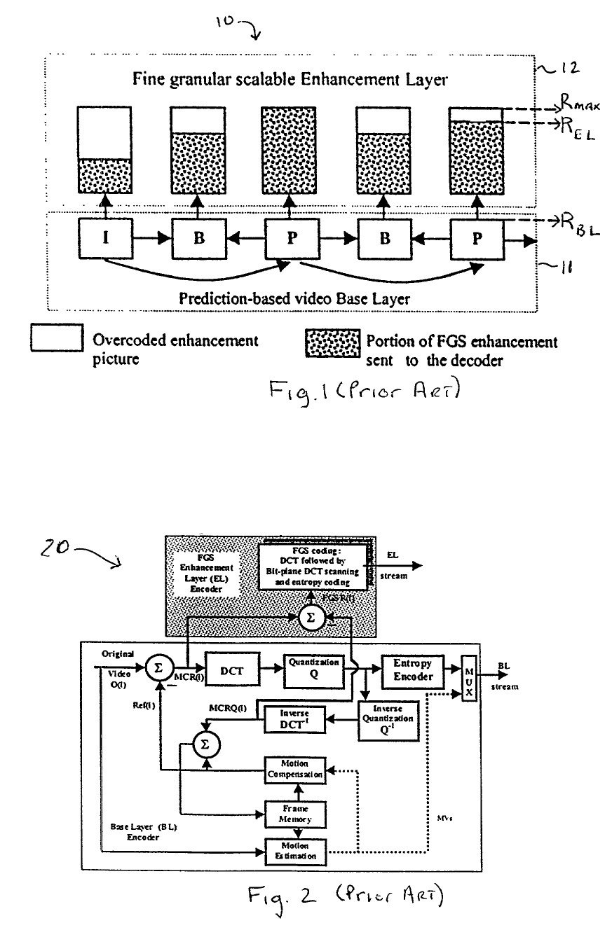

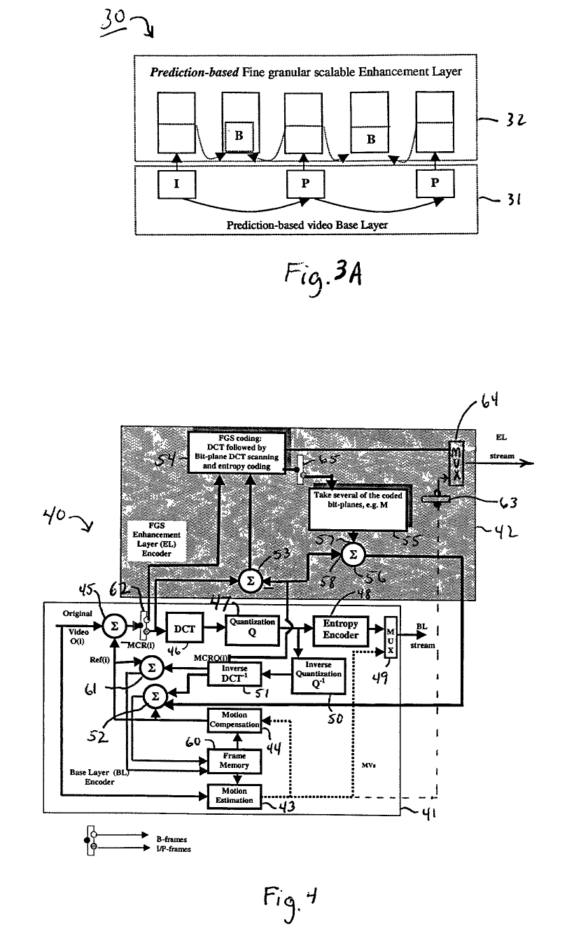

### DETAILED DESCRIPTION OF THE INVENTION

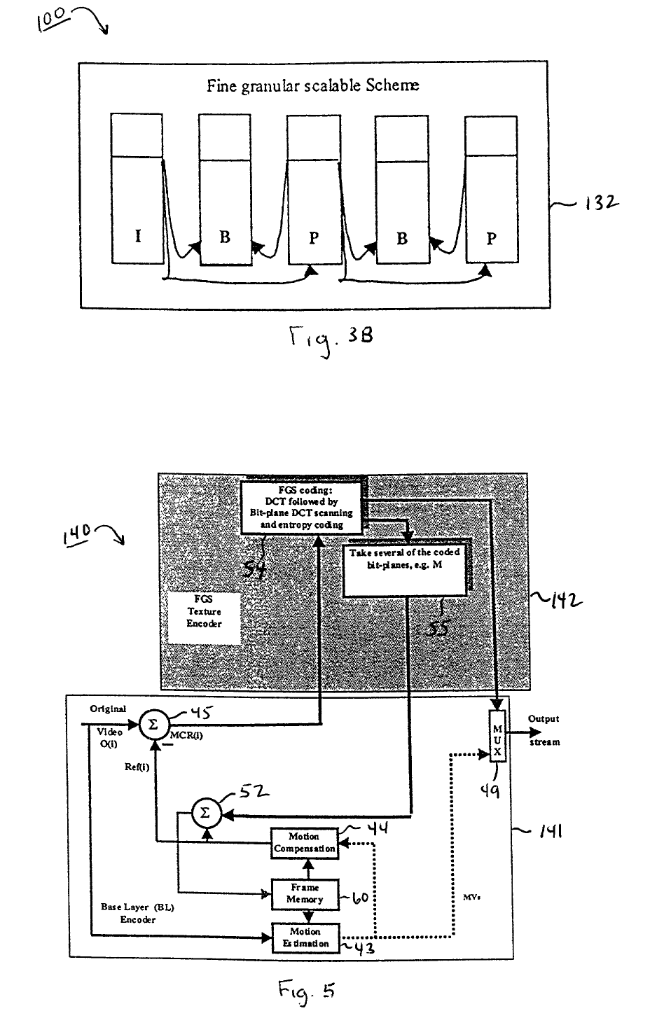

FIG. 3A shows a scalable video coding scheme 30 according to a first exemplary embodiment of the present invention. The scalable video coding scheme 30 includes a prediction-based base layer 31 and a single-loop prediction-based enhancement layer 32.

The prediction-based base layer 31 is coded to include intraframe coded I frames and interframe coded P frames, which are generated conventionally during base layer (non-scalable) coding from standard base layer I and P reference frames. No interframe coded bi-directional B frames are coded in the base layer.

In accordance with the principles of the present invention, the prediction-based enhancement layer 32 is coded to include interframe coded bi-directional B frames, which are motion-predicted from “extended” or “enhanced” base layer I and P or P and P reference frames (hereinafter extended base layer I and P reference frames) during base layer coding. Each extended base layer reference frame comprises a standard base layer reference frame, and at least a portion of an associated enhancement layer reference frame (one or more bitplanes or fractional bit-planes of the associated enhancement layer reference frame can be used).

The enhancement layer 32 is also coded to include enhancement layer I and P frames that are generated conventionally by subtracting their respective reconstructed (decoded) base layer frame residuals from their respective original base layer frame residuals. The enhancement layer I, B, and P frames may be coded with any suitable a scalable codec. For example, the scalable codec may be a DCT-based codec (FGS), a wavelet-based codec, or any other embedded codec. In the embodiment shown in FIG. 3A, the scalable codec comprises FGS.

As one of ordinary skill in the art will appreciate, the video coding scheme 30 of the present invention improves the image quality of the video. This is because the video coding scheme 30 uses extended base layer reference frames to reduce temporal redundancy in the enhancement layer B frames.

FIG. 4 shows a block-diagram of an encoder 40, according to an exemplary embodiment of the present invention, that may be used for generating the scalable video coding scheme of FIG. 3A. As can be seen, the encoder 40 includes a base layer encoder 41 and an enhancement layer encoder 42. The base layer encoder 41 includes a motion estimator 43 that generates motion information (motion vectors and prediction modes) from the original video sequence and base layer and extended base layer reference frames stored in frame memory 60. This motion information is then applied to a motion compensator 44 that generates conventional motion-compensated base layer reference frames and motion-compensated versions of the extended base layer I and P reference frames of the present invention (all denoted Ref(i)) using the motion information and conventional reference frames and the extended base layer I and P reference frames stored in the frame memory 60. A first subtractor 45 subtracts the conventional motion-compensated reference frames from the original video sequence to generate motion-compensated residuals of the base layer I and P frames. A first frame flow control device 62 routes just the motion-compensated residuals of the base layer I and P frames MCR(i) for processing by a discrete cosine transform (DCT) encoder 46, a quantizer 47, and an entropy encoder 48 to generate the base layer I and P frames, which form a portion of a compressed base layer stream. The motion information generated by the motion estimator 43 is also applied to a multiplexer 49, which combines the motion information with the base layer I and P frames to complete the compressed base layer stream. The quantized motion-compensated residuals of the base layer I and P frames MCR(i) generated at the output of the quantizer 47 are dequantized by an inverse quantizer 50, and then decoded by an inverse DCT decoder 51. This process generates quantized/dequantized versions of the motion-compensated residuals of the base layer I and P frames MCRQ(i) at the output of the inverse DCT 51. The quantized/dequantized motion-compensated residuals of the base layer I and P frames at the output of the inverse DCT 51 are applied to a first adder 61, which sums them with corresponding motion-compensated base layer reference frames Ref(i), hence generating the conventional base layer reference frames that are stored in the frame memory 60 as described above.

The quantized/dequantized motion-compensated residuals of the base layer I and P frames are also applied to a second subtractor 53 in the enhancement layer encoder 42. The second subtractor 53 subtracts the quantized/dequantized motion-compensated residuals of the base layer I and P frames from corresponding motion-compensated residuals of the base layer I and P frames to generate differential I and P frame residuals. The output of the second subtractor 53 is scalable coded by an FGS encoder 54 or like scalable encoder. The FGS encoder 54 uses conventional DCT encoding followed by conventional bit-plane DCT scanning and conventional entropy encoding to generate scalable (FGS) encoded I and P frames, which form a portion of a compressed enhancement layer stream. A masking device 55 takes one or more of the coded bit planes of the scalable encoded I and P frames, selectively routed through a third frame flow control device 65, and applies this data to a first input 57 of a second adder 56. The quantized/dequantized versions of the motion-compensated residuals of the I and P frames MCRQ(i) generated by the base layer encoder 41 are further applied to a second input 58 of the second adder 56. The second adder 56 generates enhancement layer I and P reference frames by summing the one or more coded bit planes of the enhancement layer encoded I and P frames with respective I and P frame residuals MCRQ(i). The enhancement layer I and P reference frames computed by the second adder 56 are applied to a third adder 52 in the base layer encoder 41. The third adder 52 sums the enhancement layer I and P reference frames with corresponding motion-compensated base layer I and P reference frames Ref(i) and corresponding quantized/dequantized motion-compensated base layer I and P frame residuals to generate the extended base layer I and P reference frames, which are stored in the frame memory 60.

The motion compensator 44 generates motion-compensated versions of the extended base layer I and P reference frames using the motion information and the extended base layer I and P reference frames stored in the frame memory 60. The first subtractor 45 subtracts the motion-compensated extended base layer reference frames from the original video sequence to generate motion-compensated B frame residuals. The first frame control device 62 routes the motion-compensated B frame residuals to the scalable (FGS) encoder 54 of the enhancement layer encoder 42, for scalable encoding. The scalable (FGS) encoded B frames form the remaining portion of the compressed enhancement layer stream. The motion information pertaining to the B frames generated by the motion estimator 43 is also applied to a second multiplexer 64 in the enhancement layer encoder 42, via a third frame control device 63. The second multiplexer 64 combines the B frame motion information with the enhancement layer frames to complete the compressed enhancement layer stream.

FIG. 6 shows a block-diagram of a decoder 70, according to an exemplary embodiment of the present invention, that may be used for decoding the compressed base layer and enhancement layer streams generated by the encoder 40 of FIG. 4. As can be seen, the decoder 70 includes a base layer decoder 71 and an enhancement layer decoder 72. The base layer decoder 71 includes a demultiplexer 73 which receives the encoded base layer stream and demultiplexes the stream into a first data stream 75a that contains motion information, and a second data stream 75b that contains texture information. The enhancement layer decoder 72 includes a demuliplexer 92 which receives the encoded enhancement layer stream and demultiplexes this stream into a third data stream 74a that contains texture information, and a fourth data stream 74b that contains motion information. The motion compensator 76 uses the motion information in the fourth data stream 74b and extended base layer reference frames stored in an associated base layer frame memory 77 to reconstruct the motion-compensated extended base layer reference (I and P) frames. The motion compensator 76 uses the I and P motion information in the first data stream 75a and conventional base layer reference frames stored in the base layer frame memory 77 to reconstruct the conventional motion-compensated base layer (I and P ) reference frames. The motion-compensated extended base layer reference frames and the conventional motion-compensated base layer reference frames are then processed by a second frame flow control device 93 as will be explained further on.

The texture information in the second data stream 75b is applied to a base layer variable length code decoder 81 for decoding, and to an inverse quantizer 82 for dequantizing. The dequantized coefficients are applied to an inverse discrete cosine transform decoder 83 where the dequantized code is transformed into the base layer frame residuals which are applied to a first input 80 of a first adder 78. The first adder 78 sums the base layer P frame residuals with their respective motion compensated base layer reference frames selectively routed by the second frame flow control device 93 to a second input 79 of the first adder, and outputs the motion-predicted P frames. (The base layer I frame residuals are outputted by the first adder 78 as base layer I frames.) The I and P base layer frames outputted by the first adder 78 are stored in the base layer frame memory 77 and form the conventional base-layer reference frames. Additionally, the I and P frames outputted by the first adder 78 may be optionally outputted as a base layer video.

The enhancement layer decoder 72 includes an FGS bit-plane decoder 84 or like scalable decoder that decodes the compressed enhancement layer stream to reconstruct the differential I and P frame residuals and B frame residuals, which are applied to a second adder 90. The I and P differential frame residuals are also selectively routed by a first frame flow control device 85 to a masking device 86 that takes one or more of the reconstructed enhancement-layer bit-planes (or fractions thereof) of the differential I and P frame residuals and applies them to a first input 88 of a third adder 87. The third adder 87 sums the I and P frame residuals with corresponding base layer I and P frames applied at a second input 89 thereof by the base layer decoder 71 to reconstruct the extended base layer I and P reference frames, which are stored in the frame memory 77.

The motion-compensated extended base layer I and P reference frames are selectively routed by the second frame flow control device 93 to the second adder 90, which sums the motion-compensated extended base layer I and P reference frames with corresponding B frame residuals and B frame motion information (transmitted in the compressed enhancement layer stream) to reconstruct the enhancement layer B frames.

The base layer I and P frames outputted by the first adder 78 of the base layer decoder 71 are selectively routed by a third frame flow control device 91 to the second adder 90, which sums the enhancement layer I and P frames with respective base layer I and P frames to generate enhanced I and P frames. The enhanced I and P frame and the enhancement layer B are outputted by the second adder 90 as an enhanced video.

FIG. 3B shows a scalable video coding scheme 100 according to a second exemplary embodiment of the present invention. The scalable video coding scheme 100 of the second embodiment only includes a single-loop prediction-based scalable layer 132 having intraframe coded I frames; interframe-coded, motion-predicted P frames; and interframe-coded, motion-bidirectional-predicted B frames. In this embodiment, all the frames (I, P, and B frames) are coded entirely with a scalable codec. The scalable codec can be DCT-based (FGS), wavelet-based, or any other embedded codec. The P and B frames are motion-predicted entirely from extended base layer I and P or P and P reference frames during encoding.

As one of ordinary skill in the art will appreciate, the elimination of a base layer makes this coding scheme very efficient and further improves the video image quality because it reduces temporal redundancy in both the enhancement layer P and B frames.

FIG. 5 shows a block-diagram of an encoder 140, according to an exemplary embodiment of the present invention, that may be used for generating the scalable video coding scheme of FIG. 3B. As can be seen, the encoder 140 of FIG. 5 includes a motion-compensation and estimation unit 141 and a scalable texture encoder 142. The motion-compensation and estimation unit 141 includes a frame memory 60 which contains the extended base layer I and P reference frames. A motion estimator 43 generates motion information (motion vectors and prediction modes) from the original video sequence and the extended base layer I and P reference frames stored in frame memory 60. This motion information is then applied to a motion compensator 44 and a multiplexer 49. The motion compensator 44 generates motion-compensated versions of the extended base layer I and P reference frames Ref(i) using the motion information and the extended base layer I and P reference frames stored in the frame memory 60. A subtractor 45 subtracts the motion-compensated versions of the extended base layer reference frames Ref(i) from the original video sequence to generate motion-compensated frame residuals MCR(i).

The scalable texture encoder 142 includes a conventional FGS encoder 54 or like scalable encoder. In the case of the FGS encoder 54, the motion-compensated frame residuals outputted by the subtractor 45 of the base layer encoder 41 are DCT encoded, bit-plane DCT scanned, and entropy encoded to generate compressed enhancement layer (FGS coded) frames. The multiplexer 49 generates a compressed output stream by combining the compressed enhancement layer frames with the motion information generated by the motion estimator 43. A masking device 55 takes one or more of the coded bit planes of the enhancement layer coded I and P frames and applies them to an adder 52. The adder 52 sums this data with the corresponding motion-compensated extended base layer I and P reference frames Ref(i) to generate new extended base layer I and P reference frames that are stored in the frame memory 60.

The scalable video coding schemes of the present invention can be alternated or switched with the current video coding scheme of FIG. 1 for the various portions of a video sequence or for various video sequences. Additionally, switching can be performed among the scalable video coding schemes of FIGS. 3A, 3B and the current video coding scheme of FIG. 1, and/or the video coding schemes described in the earlier-mentioned related copending U.S. Patent Applications and/or other video coding schemes. Such switching of video coding schemes can be done based on channel characteristics and can be performed at encoding or at transmission time. Further the video coding schemes of the present invention achieve a large gain in coding efficiency with only a slight increase (FIG. 3A), or decrease (FIG. 3B) in complexity.

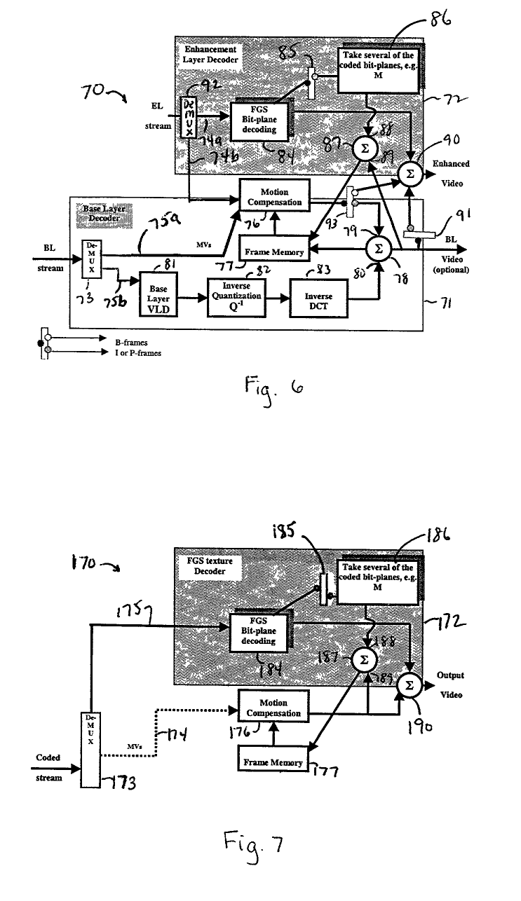

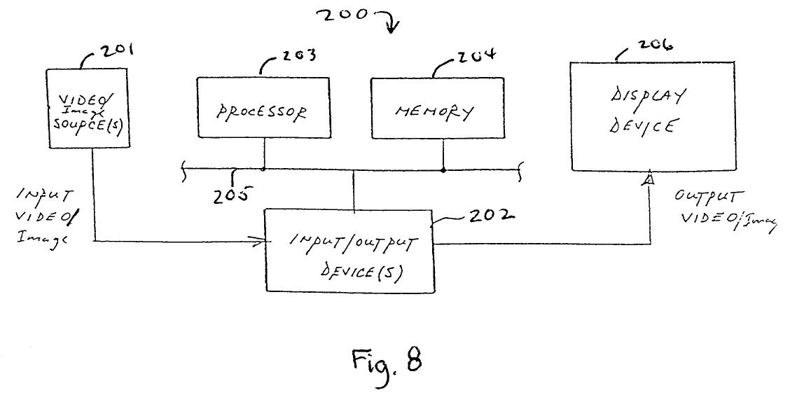

FIG. 7 shows a block-diagram of a decoder 170, according to an exemplary embodiment of the present invention, that may be used for decoding the output stream generated by the encoder 140 of FIG. 5. As can be seen, the decoder 170 includes a demultiplexer 173 which receives the encoded scalable stream and demultiplexes the stream into first and second data streams 174 and 175. The first data stream 174, which includes motion information (motion vectors and motion prediction modes), is applied to a motion compensator 176. The motion compensator 176 uses this motion information and extended base layer I and P reference frames stored in base layer frame memory 177 to reconstruct the motion-compensated extended base layer I and P reference frames.

The second data stream 175 demultiplexed by the demultiplexer 173 is applied to a texture decoder 172, which includes an FGS bit-plane decoder 184 or like scalable decoder that decodes the second data stream 175 to reconstruct the I, P, and B frame residuals, which are applied to a first adder 190. The I and P frame residuals are also applied to a masking device 186 via a frame flow control device 185 that takes one or more of the coded bit-planes (or fractions thereof) of the I and P frame residuals and applies them to a first input 188 of a second adder 187. The second adder 187 sums the I and P frame residual data with corresponding reconstructed motion-compensated extended base layer I and P frames applied at a second input 189 thereof by the motion compensator 176 to reconstruct new extended base layer I and P reference frames, which are stored in the frame memory 177.

The motion-compensated extended base layer I and P reference frames are also routed to the first adder 190, which sums them with corresponding reconstructed frame residuals (from the FGS decoder 184) to generate enhanced I, P and B frames, which are outputted by the first adder 190 as an enhanced video.

FIG. 8 shows an exemplary embodiment of a system 200 which may be used for implementing the principles of the present invention. The system 200 may represent a television, a set-top box, a desktop, laptop or palmtop computer, a personal digital assistant (PDA), a video/image storage device such as a video cassette recorder (VCR), a digital video recorder DVR), a TiVO device, etc., as well as portions or combinations of these and other devices. The system 200 includes one or more video/image sources 201, one or more input/output devices 202, a processor 203 and a memory 204. The video/image source(s) 201 may represent, e.g., a television receiver, a VCR or other video/image storage device. The source(s) 201 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 202, processor 203 and memory 204 may communicate over a communication medium 205. The communication medium 205 may represent, e.g., a bus, a communication network, one or more internal connections of a circuit, circuit card or other device, as well as portions and combinations of these and other communication media. Input video data from the source(s) 201 is processed in accordance with one or more software programs stored in memory 204 and executed by processor 203 in order to generate output video/images supplied to a display device 206.

In a preferred embodiment, the coding and decoding employing the principles of the present invention may be implemented by computer readable code executed by the system. The code may be stored in the memory 204 or read/downloaded from a memory medium such as a CD-ROM or floppy disk. In other embodiments, hardware circuitry may be used in place of, or in combination with, software instructions to implement the invention. For example, the elements shown in FIGS. 4-7 may also be implemented as discrete hardware elements.

While the present invention has been described above in terms of specific embodiments, it is to be understood that the invention is not intended to be confined or limited to the embodiments disclosed herein. For example, other transforms besides DCT can be employed, including but not limited to wavelets or matching-pursuits. These and all other such modifications and changes are considered to be within the scope of the appended claims.

What is claimed is:

1. A method of coding video, comprising the steps of:
encoding an uncoded video to generate extended base layer reference frames, each of the extended base layer reference frames including a base layer reference frame and at least a portion of an associated enhancement layer reference frame; and
generating frame residuals from the uncoded video and the extended base layer reference frames.

2. A method of coding video according to claim 1, further comprising the step of coding the frame residuals with a scalable codec selected from the group consisting of DCT based codecs or wavelet based codecs to generate enhancement layer frames.

3. A method of coding video according to claim 1, further comprising the step of coding the frame residuals with a fine granular scalable codec to generate fine granular scalable enhancement layer frames.

4. A method of coding video according to claim 1, wherein the frame residuals include B frame residuals.

5. A method of coding video according to claim 4, wherein the frame residual further include P frame residuals.

6. A method of coding video according to claim 1, wherein the frame residual include P frame residuals.

7. A method of decoding a compressed video having a base layer stream and an enhancement layer stream, the method comprising the steps of:
decoding the base layer and enhancement layer streams to generate extended base layer reference frames, each of the extended base layer reference frames including a base layer reference frame and at least a portion of an associated enhancement layer reference frame; and
predicting frame residuals from the extended base layer reference frames.

8. A method of decoding video according to claim 7, further comprising the step of decoding the frame residuals with scalable decoding selected from the group consisting of DCT based decoding or wavelet based decoding.

9. A method of decoding video according to claim 8, further comprising the steps of:
generating enhancement layer frames from the frame residuals; and
generating an enhanced video from the base layer frames and the enhancement layer frames.

10. A method of decoding video according to claim 7, wherein the frame residuals include B frame residuals.

11. A method of decoding video according to claim 10, wherein the frame residuals further include P frame residuals.

12. A method of decoding video according to claim 7, wherein the frame residuals include P-frame residuals.

13. A memory medium for coding video, the memory medium comprising:
code for encoding an uncoded video to generate extended base layer reference frames, each of the extended base layer reference frames including a base layer reference frame and at least a portion of an associated enhancement layer reference frame; and
code for predicting frame residuals from the uncoded video and the extended base layer reference frames.

14. A memory medium for coding video according to claim 13, further comprising code for scalable encoding the frame residuals.

15. A memory medium for coding video according to claim 13, further comprising code for fine granular scalable encoding the frame residuals.

16. A memory medium for coding video according to claim 13, wherein the frame residuals include B frame residuals.

17. A memory medium for coding video according to claim 16, where in th e frame residuals further include P frame residuals.

18. A memory medium for coding video according to claim 13, wherein the frame residuals include P frame residuals.

19. A memory medium for decoding a compressed video having a base layer stream and an enhancement layer stream, the memory medium comprising:
code for decoding the base layer and enhancement layer streams to generate extended base layer reference frames, each of the extended base layer reference frames including a base layer reference frame and at least a portion of an associated enhancement layer reference frame; and
code for predicting frame residuals from the extended base layer reference frames.

20. A memory medium for decoding a compressed video according to claim 19, further comprising code for scalable decoding the frame residuals, the code for scalable decoding selected from the group consisting of DCT based code or wavelet based code.

21. A memory medium for decoding a compressed video according to claim 20, further comprising:
code for generating enhancement layer frames from the frame residuals; and
code for generating an enhanced video from the base layer frames and the enhancement layer frames.

22. A memory medium for decoding a compressed video according to claim 19, wherein the frame residuals include B frame residuals.

23. A memory medium for decoding a compressed video according to claim 22, wherein the frame residuals further include P frame residuals.

24. A memory medium for decoding a compressed video according to claim 19, wherein the frame residuals include P frame residuals.

25. An apparatus for coding video, the apparatus comprising:
means for encoding an uncoded video to generate extended base layer reference frames, each of the extended base layer reference frames including a base layer reference frame and at least a portion of an associated enhancement layer reference frame; and
means for predicting frame residuals from the uncoded video and the extended base layer reference frames.

26. An apparatus for coding video according to claim 25, further comprising means for scalable encoding the frame residuals.

27. An apparatus for coding video according to claim 25, further comprising code for fine granular scalable encoding the frame residuals.

28. An apparatus for coding video according to claim 25, wherein the frame residuals include B frame residuals.

29. An apparatus for coding video according to claim 28, wherein the frame residuals further include P frame residuals.

30. An apparatus for coding video according to claim 25, wherein the frame residuals include P frame residuals.

31. An apparatus for decoding a compressed video having a base layer stream and an enhancement layer stream, the apparatus comprising:
means for decoding the base layer and enhancement layer streams to generate extended base layer reference frames, each of the extended base layer reference frames including a base layer reference frame and at least a portion of an associated enhancement layer reference frame; and
means for predicting frame residuals from the extended base layer reference frames.

32. An apparatus for decoding a compressed video according to claim 31, further comprising scalable decoding means for decoding the frame residuals, the scalable decoding means selected from the group consisting of DCT based decoding means or wavelet based decoding means.

33. An apparatus for decoding a compressed video according to claim 32, further comprising:
means for generating enhancement layer frames from the frame residuals; and
means for generating an enhanced video from the base layer frames and the enhancement layer frames.

34. An apparatus for decoding a compressed video according to claim 31, wherein the frame residuals include B frame residuals.

35. An apparatus for decoding a compressed video according to claim 34, wherein the frame residuals further include P frame residuals.

36. An apparatus for decoding a compressed video according to claim 31, wherein the frame residuals include P frame residuals.
